(19) United States
(12) Patent Application Publication
(10) Pub. No.: US 2025/0154047 A1
(43) Pub. Date: May 15, 2025

(54) METHOD AND SEMI-FINISHED PRODUCT FOR PRODUCING A MULTICORE FIBRE

(71) Applicant: Heraeus Quarzglas GmbH & Co. KG, Hanau (DE)

(72) Inventors: Michael LORENZ, Bitterfeld-Wolfen (DE); Kay SCHUSTER, Bitterfeld-Wolfe (DE); Tobias TIESS, Bitterfeld-Wolfen (DE)

(21) Appl. No.: 18/728,726

(22) PCT Filed: Jan. 17, 2023
(86) PCT No.: PCT/EP2023/050959

§ 371 Date: Jul. 12, 2024

(30) Foreign Application Priority Data
Jan. 18, 2022 (EP) 22151954.9

(51) Int. Cl. C03B 37/012

(52) U.S. Cl. CPC C03B 37/01222; C03B 2203/34

(57) ABSTRACT

A known method for producing a multicore fiber having a marker zone close to the edge comprises a method step in which a component group is reshaped to form the multicore fiber or to form a pre-form for the multicore fiber. In order to provide a method on this basis for producing multicore fibers having a marker zone close to the edge, in which the risk of rejects is reduced, the marker element is arranged on the an outer lateral surface of a glass cladding cylinder, wherein a longitudinal groove is created in the outer lateral surface of the glass cladding region and extending in the direction of a cylinder longitudinal axis, and the marker element is melted in the longitudinal groove before the reshaping to form the pre-form or the multicore fiber.

### TECHNICAL BACKGROUND

The present invention relates to a method for producing a multicore fiber, comprising a method step in which a component group is reshaped to form the multicore fiber or to form a pre-form for the multicore fiber, wherein the component group comprises:
a cylinder having a cylinder longitudinal axis and an outer lateral surface and having a glass cladding region made of cladding glass,
a plurality of glass core regions provided with a core glass and extending in the direction of the cylinder longitudinal axis, which are surrounded by the cladding glass, and at least one marker element extending in the direction of the cylinder longitudinal axis.

In addition, the invention relates to a semi-finished product for producing a multicore fiber, comprising a glass cladding cylinder having a cylinder longitudinal axis and an outer lateral surface and having a glass cladding region made of cladding glass which contains a plurality of openings for receiving core rods made of a core glass.

In multicore fibers, a plurality of light wave-conducting optical core regions (also referred to below as “signal cores”) are integrated in a common fiber. The signal cores extend along the longitudinal axis of the fiber. They are surrounded by cladding material with a lower refractive index and enable substantially independent light guidance. This fiber design promises a high signal transmission capacity, because different signals, combined in a single optical fiber, can be transmitted simultaneously in each of the spatially separated signal cores. This signal transmission method is also referred to as “spatial multiplexing”, which in particular can increase the data transmission capacity in optical telecommunications. Multicore fibers are also regarded as key components for transmitting energy for material processing, as a component of fiber optic sensors in measuring and medical technology, and are considered for lighting and imaging purposes in microscopic or endoscopic devices.

### PRIOR ART

Multicore fibers are produced by elongating a solid pre-form or a group of components. These frequently consist of synthetically produced quartz glass (SiO₂), which may be doped or undoped. The production of synthetic quartz glass comprises, for example, plasma or CVD deposition methods known by the names OVD, VAD, MCVD, PCVD or FCVD methods. A liquid or gaseous silicon-containing starting substance is subjected to a chemical reaction (hydrolysis, pyrolysis or oxidation), and the reaction product—particulate SiO₂—is deposited as a solid from the gas phase on a deposition surface. The starting substance is, for example, silicon tetrachloride (SiCl₄) or a chlorine-free silicon compound, such as a polyalkyl siloxane. The reaction zone is, for example, a burner flame, an electric arc (plasma) or a furnace.

In the so-called “stack and draw” method, core rods and glass cylinders of different diameters are stacked such that they create a relatively high packing density and a certain degree of symmetry. The cylindrical components are inserted into a cladding tube and are spatially fixed therein. This group is drawn to form the multicore fiber or is processed further in advance to form a pre-form from which the multicore fiber is then drawn.

The “stack-and-draw” method requires a high level of adjustment effort and easily results in errors in dimensional stability and in the introduction of impurities resulting from the large proportion of free component surfaces. In addition, due to differences in the radial packing density, the elongated pre-form often has different radius values in the azimuthal direction, which have to be compensated for by cylindrical grinding.

A semi-finished product and a method for producing a multicore fiber by elongating the semi-finished product are known from US 2016/347645 A1. The semi-finished product forms a multipart fiber pre-form which is composed of a one-piece cladding tube made of cladding glass, designed for receiving and axially guiding a stack of three structurally identical cylindrical stack pieces made of cladding glass, each of which comprise through-bores and a longitudinal groove in the cylinder cladding surface thereof, a plurality of core rods for insertion into the through-bores, and a plurality of marker rods for insertion into the longitudinal grooves. Within the cladding tube bore, the stack pieces are arranged on top of one another such that the through-bores and the longitudinal grooves are aligned. The marker zone of the fiber pre-form formed by the marker rods runs on the inner cladding surface of the cladding tube.

US 2016/070058 A1 discloses a pre-form and a method for producing a multicore fiber by elongating the pre-form. The pre-form has a flattened portion on its outer lateral surface which can serve as a marker element. In the fiber drawing process, the multicore fiber is coated with a plastics coating.

In the method known from US 2015/284286 A1 and from US 2015/0307387 A1, a soot body based on SiO₂ and produced by the OVD method (SiO₂ soot body) is used as a glass cladding cylinder and has a density between 0.8 g/cm³ and 1.6 g/cm³. In the OVD method, the deposition surface is generally the outer lateral surface of a rod-shaped or tubular deposition mandrel rotating about its longitudinal axis. A substantially cylindrical soot body is deposited by a reversing back and forth movement of the reaction zone. After completion of the deposition process, the deposition mandrel is removed so that a central through-opening remains in the central axis of the cylindrical soot body. Longitudinal bores for receiving core glass rods are introduced into the hollow glass cladding cylinder produced in this way, wherein the lower density of the SiO₂ soot body compared to quartz glass makes it easier to produce dimensionally accurate longitudinal bores. The central “OVD through-opening” remaining due to the production process can lead to asymmetrical deformations during collapse and destroy the fiber design. In addition, the collapse causes the cross-sectional area of the cladding glass proportion to be reduced. These disadvantages can be avoided by using a component which closes the OVD through-opening. This can be, for example, a core rod or a filling rod. The filling rod consists of glass which has substantially the same refractive index as the hollow glass cladding cylinder. The filling rod can also be produced by an OVD method or by press molding or by a combination of press molding and an OVD method. Additionally, a channel for receiving a marker element is made in the hollow glass cladding cylinder. The channel is produced by mechanical drilling in the region of the hollow glass cladding cylinder that is close to the edge.

In the multicore fiber, the marker elements form continuous line-like marker zones and serve to break the symmetry about the signal cores and to unambiguously identify their positions relative to one another and in relation to the fiber central axis and to be able to unambiguously assign said positions to one another. This is necessary, for example, so that two multicore fibers can be joined together with low attenuation by means of their end faces using conventional splicing methods.

To splice the multicore fiber, the fiber ends to be connected are arranged such that their end faces face one another. In a known method, light is simultaneously fed into all signal cores at the opposite fiber end, and is collectively detected at the fiber end of the other multicore fiber by means of a photodetector and power meters. In particular in cases in which one end of the multicore fiber is not available for feeding light in, this multicore fiber is laterally irradiated with light. By relative displacement of the multicore fiber end faces in the horizontal and vertical directions and by relative rotation in the azimuthal direction, the fiber ends are automatically aligned with one another in a fusion splicing machine until the signal cores are correctly assigned to one another and the collective light power received is at a maximum, and are then fused to one another in this position.

This splicing method presupposes that the multicore fiber is spliced in advance, for example, in a factory. In order to enable simple splicing of multicore fibers at the laying location, U.S. Pat. No. 9,541,707 B2 proposes a design of the multicore fiber in which a plurality of signal cores are arranged in a glass cladding region, and in which a marking zone is exposed on the outer lateral surface of the multicore fiber. The particular characteristic of this fiber design is also referred to below as the “marker zone close to the edge”.

In order to produce the multicore fiber with a marker zone close to the edge, a plurality of through-bores, which run in the direction of the longitudinal cylinder axis, are produced in a glass cladding cylinder. Specifically, a plurality of core rod bores and a marker rod bore. The marker rod bore lies as close as possible to the outer lateral surface of the glass cladding cylinder. A core rod is inserted into each of the core rod bores and a marker rod is inserted into the marker rod bore. The outer circumference of the glass cladding cylinder is then ground down until a portion of the marker rod is exposed. The multicore fiber is drawn from the component group prepared in this way, on the surface of which the marker zone is exposed.

### TECHNICAL OBJECT

The glass cladding cylinder is elongated. The through-holes thus have a large aspect ratio (ratio of length and diameter), which in principle makes their dimensionally accurate production and exact alignment in parallel with the longitudinal axis of the glass cladding cylinder more difficult.

The greater the number of multiple cores, the greater theoretically the increase in the data transmission capacity compared to an optical fiber having a single fiber core (single-mode fiber or multi-mode fiber). On the other hand, there is in principle the requirement for each of the multiple cores to have optical attenuation which corresponds approximately to that of an optical fiber with a single core. This requires that the fiber design does not cause any additional attenuation, or does not impair the independent information transmission of the signal cores as an interference signal. However, this can be caused by so-called “crosstalk” between the multiple cores in particular if they are too close to one another. This effect thus requires a certain minimum distance to be maintained between the fiber cores. For these reasons, there is a need to use the cross-sectional area available in the radial cross section of the multicore fiber as completely as possible for occupancy by the multiple cores.

In addition, marker zones are always imperfections in the multicore fiber, which in principle should be as small as possible but should be as large as necessary in order to ensure their detectability. A small size of the marker zones is also advantageous in order to counteract other undesired effects, such as so-called fiber curl or stresses induced in the fiber.

The marker zones additionally to be introduced into the fiber design should therefore occupy the smallest possible proportion of the fiber cross section. The diameter of the channel for receiving the marker element is therefore small and generally significantly smaller than the diameter of the bores for receiving the core rods. Typically, the channel diameter in the glass cladding cylinder prior to the fiber drawing process is less than 15 mm, accompanied by an aspect ratio above 65 (with a cylinder length of about 1 m).

The dimensionally accurate production and exact alignment of such thin channels in a glass cladding cylinder are difficult, even when high-precision drilling machines are used. The costs for producing the glass cladding cylinder from synthetic quartz glass are great and the loss is particularly painful if, of all things, it is the small bore for receiving the marker element that leads to the otherwise finished glass cladding cylinder being rejected.

To make matters worse, in the case of the marker rod bore close to the edge, only a thin residual wall remains, which can easily break both during the production of the through-bore and during further processing, in particular when the marker rod is inserted.

The grinding down of the outer circumference of the glass cladding cylinder according to U.S. Pat. No. 9,541,707 B2 takes place when through-bores are completely equipped with the core rods and marker rod. Apart from the fact that grinding down must be carried out with greatest care and therefore requires a lot of time and expense, this method stage carries the risk of total loss.

It is therefore an object of the invention to provide a method for producing multicore fibers with a marker zone close to the edge, which reduces the disadvantages of the known methods, and in which, in particular, the risk of rejects is reduced.

In addition, the object of the invention is to provide a semi-finished product suitable for carrying out the method.

### GENERAL DESCRIPTION OF THE INVENTION

With regard to the method, this object is achieved according to the invention and based on the method mentioned at the outset in that the marker element is arranged on the outer lateral surface of the glass cladding cylinder, wherein a longitudinal groove is created in the outer lateral surface of the glass cladding region that extends in the direction of the cylinder longitudinal axis, and in that the marker element is melted in the longitudinal groove before reshaping to form the pre-form or the multicore fiber.

At least one longitudinal groove is created in the outer lateral surface of the glass cladding region that extends in the direction of the longitudinal cylinder axis, in which groove the marker element is arranged and melted. Arranging the marker element on the outer lateral surface of the glass cladding cylinder comprises, for example, attaching a marker element in the form of a component in the longitudinal groove in the outer lateral surface and the application, deposition or pressing of a marker element in the form of a layer or mass in the longitudinal groove in the outer lateral surface.

This procedure has several advantages over the prior art:
(1) The effort for creating a bore for receiving the marker element in the glass cladding cylinder is removed, as is the associated risk of failure.
(2) The marker element melted in the longitudinal groove is exposed on the outer lateral surface. In contrast to the method known from U.S. Pat. No. 9,541,707 B2, the effort and the risk of failure when removing cladding glass material and exposing the marker glass are therefore also removed.
(3) By virtue of the fact that the marker element adjoins the outer lateral surface, alignment of the marker element in parallel with the axis is achieved. The dimensional stability and straightness of the outer lateral surface of the glass cladding cylinder can be ensured comparatively easily. For example, by mechanical machining or by an elongation process, by means of which a starting cylinder is elongated to form a cylinder strand, from which the glass cladding cylinder is produced or from which a plurality of glass cladding cylinders are cut to length. In order to prevent damage to the surface, the elongation process preferably takes place without the use of a molding tool which engages on the drawn-off cylinder strand.
(4) The creation of a bore for receiving the marker element can be dispensed with. The arrangement on the outer lateral surface allows for particularly small marker elements having aspect ratios of virtually any size.
(5) By melting the marker element into the longitudinal groove before reshaping the component group to form a multicore fiber or a pre-form, it can be ensured that the side edges of the longitudinal groove filled with the melted marker element form largely stepless, continuous transitions to the outer lateral surface of the glass cladding region, and thus structural defects are avoided during the fiber drawing process. This has a positive effect on the dimensional stability of the multicore fiber. The marker element optionally completely fills the longitudinal groove and ideally has a curvature adapted to the outer contour of the outer lateral surface.
   When the spatial volume of the longitudinal groove and the volume occupied by the marker element after melting are approximately the same size, this contributes to the complete filling of the longitudinal groove. Realizing this is simplified if, before melting, the marker element can project to any desired extent relative to the longitudinal groove upper edge and the height of this projection is not limited by an outer cladding tube or the like. Such a limitation can be omitted in the method according to the invention.
(6) In the splicing process, the marginal marker can be optically detected comparatively easily.
(7) In addition, the azimuthal alignment accuracy of the multicore fiber is high for the splicing process, since the marginal position of the marker reacts particularly sensitively to angular deviations.
   The edge position of the marker zone in the multicore fiber results from the likewise marginal position of the marker element on the outer cladding of the glass cladding region of the component group or on the outer cylinder cladding surface of the pre-form. Here, “marginal” means that the marker element is part of the outer lateral surface of the glass cladding region of the component group or of the outer lateral surface of the pre-form.

The component group is equipped with a marker element without a separate bore, associated with the risks and difficulties explained above, having to be created therefor in the glass cladding cylinder. At the same time, high dimensional stability can be ensured which, for example in the pre-form or in the component group, manifests itself in that the axis parallelism of the marker element has a deviation of less than 0.3 mm/m.

The longitudinal groove is filled with the marker element, for example, by inserting a cylindrical component (rod or tube), made from a marker glass, which extends in parallel with the outer lateral surface of the glass cladding cylinder, or by introducing a bed of marker glass particles or by coating the interior of the longitudinal groove with the marker glass.

A marker element in the form of a tube can be open on both sides or at least on one side (an opening above the softening zone suffices). It is thereby possible to prevent complete collapse of the tube inner bore during reshaping of the component group to form the pre-form or multicore fiber by applying pressure so that a hollow channel (“airline”) remains in the finished multicore fiber. Alternatively or additionally, the formation of a hollow channel in the multicore fiber can also be promoted by the tube wall containing a material which has a higher viscosity than the cladding glass so that the bore does not completely collapse during the fiber drawing process.

The marker element (component, bed, layer) arranged in the longitudinal groove is fixed in the longitudinal groove by fusing. For this purpose, it is melted in the longitudinal groove over at least a portion of its length, preferably locally at a plurality of points distributed over the length thereof and ideally over the entire length thereof.

Thus, in a preferred procedure, it is provided that the marker element has a length and that said marker is melted fully, in regions or at points along at least 80% of this length, preferably along at least 90% of this length.

Melting the marker element preferably comprises a method step in which the glass cladding cylinder is mounted with a horizontally oriented cylinder longitudinal axis such that the longitudinal groove is located on an upper side, wherein the material of the marker element is heated and softened by means of a heat source.

By melting the marker element having a horizontally oriented cylinder longitudinal axis, gravity causes the material of the marker element to sink as soon as it has been locally heated and softened, for example by means of a burner or a laser, and it thereby fills cavities remaining in the longitudinal groove. The surface tension can lead to rounding of the free surface region adjacent to the atmosphere.

In this way, it is substantially easier to fill the longitudinal groove uniformly and preferably completely than would be the case, for example, if the marker element and the longitudinal groove were oriented in the vertical direction during the melting process.

The marker element melted in the longitudinal groove is fixed in relation to the glass cladding cylinder, which simplifies its handling during later stages of the fiber production process. During melting, a certain degree of rounding of the marker material and thus an adaptation to the contour of the outer lateral surface of the glass cladding cylinder can be achieved as a result of the surface tension. After melting the marker element, freedom from defects and the quality of the melting process can be monitored and, if necessary, improved.

Two or more, for example four to seven, longitudinal bores (core rod bores) are made in the glass cladding cylinder in a conventional manner, the longitudinal axes of which run in parallel with the longitudinal axis of the central bore. The core rod bores are through-bores or blind bores and serve to receive at least one core rod made from the core glass in each case. Viewed in the radial direction, the composition of the core glass is uniformly homogeneous or changes gradually or in stages. It differs from that of the cladding glass in such a way that light guidance in the core glass region is ensured.

The desired number of core rod bores is either produced in one operation and occupied in each case by at least one core rod, or only one core rod bore or only a first share of the desired number of core rod bores is produced in advance, this in each case being occupied by at least one core rod, and the core rod bores occupied by the core rods are collapsed (this reshaping process is also referred to here as “consolidation”), before the remaining share or a further share of the core rod bores is produced in a second or further operation, and this share is also occupied in each case by at least one core rod and is optionally collapsed. In the simplest case, all core rods have the same dimensions and consist of the same core glass. However, the core rods can also differ in terms of their dimensions and/or in the composition of the corresponding core glass.

Arranging the marker element on the outer lateral surface and melting it into the longitudinal groove can take place before or after all core rod bores have been produced and/or filled, or before or after some of the core rod bores have been produced and/or filled. In a preferred procedure, the marker element is arranged on the outer lateral surface and melted in the longitudinal groove, and then the desired core rod bores are produced.

The component group produced in this way is reshaped and either drawn directly to form the multicore fiber or is consolidated to form a pre-form for the multicore fiber, wherein the consolidation process can be associated with a simultaneous elongation process. The “consolidated pre-form” produced in this way is optionally drawn to form the multicore fiber or is further processed to form a “secondary pre-form”. Further processing to form the “secondary pre-form” comprises, for example, producing further bores in the glass cladding region and the coating thereof with core glass or with other glasses or the one-time or repeated performance of one or more of the following hot-forming processes: collapse, elongation, collapse, and simultaneous elongation. The multicore fiber is drawn from the secondary pre-form produced by further processing. In the multicore fiber, the marginal marker element of the component group forms a marginal marker zone.

Due to the marginal positioning of the marker zone, fiber splice devices can identify the marker zone more quickly and more precisely. Due to the comparatively simple detectability of the marginal marker zone, the marker zone can be particularly small so that the multicore fiber is given a comparatively low fiber curl during the fiber drawing process. A property of glass fibers which is defined as a degree of curvature over a certain length of the fiber is referred to as “fiber curl”. The curvature results from thermal stresses which arise during the fiber production. A high “fiber curl” makes low-attenuation splicing of the multicore fiber more difficult.

Compared to a bore, the longitudinal groove is particularly easy to manufacture in the outer lateral surface, for example by milling by means of a mechanical milling machine or by laser ablation. On the other hand, the longitudinal groove produced in this way is just as precise and straight as the glass cladding cylinder itself. Furthermore, the depth or the opening width of the longitudinal groove can virtually be as small as desired, for example both less than 15 mm, preferably less than 10 mm and particularly preferably less than 5 mm. By filling the longitudinal groove with the marker glass, geometrically precise marker elements with a small volume can thus be produced in a simple manner, which marker elements have a deviation in their axial orientation of less than 0.3 mm/m in the pre-form or in the component group and accordingly form correspondingly small and highly precise marker zones in the multicore fiber.

The marker glass completely or partially fills the longitudinal groove. In a particularly preferred method variant, cladding glass having a cladding glass volume V_{M} is removed from the glass cladding cylinder to produce the longitudinal groove, wherein a marker element having a volume V_{E} is received in the longitudinal groove, where V_{E}=V_{M}+/−0.1×V_{M}.

The marker glass volume is of such a size that the marker glass in the molten state fills the opening volume of the longitudinal groove as completely as possible and ideally fills it in such a way that it has a curvature which is adapted to the contour of the outer lateral surface. Asymmetries and defects during the fiber drawing process are thereby avoided as far as possible. The cross-sectional contours of the longitudinal groove and of the marker element do not have to coincide for this purpose. The longitudinal groove preferably has a round bottom.

In a preferred procedure, the production of the component group comprises the following method steps:
(a) providing the glass cladding cylinder, which contains the cladding glass,
(b) providing core rods containing the core glass,
(c) providing a marker element,
(d) producing at least one longitudinal groove in the outer lateral surface of the glass cladding cylinder,
(e) producing core rod bores extending along the cylinder longitudinal axis,
(f) arranging and melting the marker element in the longitudinal groove, and
(g) introducing the core rods into the core rod bores thereby forming the core glass regions.

The component group thus produced comprises the glass cladding cylinder, the marker element and at least two core rods. The list designations (a) to (g) specify only a preferred but not mandatory order of the method steps.

By attaching the marker element to the glass cladding cylinder, the marker element benefits from the straightness and alignment thereof; these properties are quasi transferred to the marker element. The marker element extends along the cylinder longitudinal axis of the glass cladding cylinder and preferably over the entire length thereof.

The marker glass preferably differs from the cladding glass and from any glass filler material in at least one physical and/or chemical property, wherein the property is selected from: refractive index, color, fluorescence and/or specific glass density.

The property (or the properties) which distinguish(es) the marker element from the glasses of the component group have an impact in particular on the visual appearance of the marker element and is/are preferably detectable by means of an optical sensor. The glass composition of a marker glass can be based on quartz glass. The refractive index of quartz glass can be changed by doping. For example, doping a marker quartz glass with fluorine causes a reduction in the refractive index with respect to undoped quartz glass. Incorporating carbon into the marker quartz glass can lead to a black coloration. Depending on the oxidation state, doping the marker quartz glass with titanium causes a gray-blue coloration. Doping the marker quartz glass with rare earth metals or germanium oxide manifests itself in fluorescence at dopant-specific wavelengths. The specific glass density of the marker element can be changed by pores and manifests itself in a reduction of the optical transparency with respect to bubble-free glass.

The glass cladding cylinder is preferably a hollow cylinder having a central bore.

Such hollow cylinders are obtained, for example, by means of the OVD (outside vapor deposition) method after the deposition mandrel has been removed. The production of hollow glass cladding cylinders based on the OVD process is cost effective in comparison with other manufacturing methods, in particular in comparison with the VAD (vapor phase axial deposition) process. However, it has the disadvantage that the aforementioned central bore can remain. This can be closed completely or partially by means of a core rod or a glass rod which contains another glass filler material.

With regard to the semi-finished product, the above-mentioned technical object is achieved by a semi-finished product having the features of claim 8.

The semi-finished product according to the invention comprises a glass cladding cylinder with openings for receiving core rods, the outer lateral surface of which has at least one recess, which extends in the direction of the cylinder longitudinal axis and is designed as a longitudinal groove, into which a marker element is melted.

The recess forms a longitudinal groove (longitudinal slot) in the outer lateral surface of the glass cladding cylinder. A longitudinal groove in the outer lateral surface is particularly easy to manufacture compared to a bore, for example by milling using a mechanical milling machine or by laser ablation. On the other hand, the longitudinal groove produced in this way is just as precise and straight as the glass cladding cylinder itself. Furthermore, the depth or the opening width of the longitudinal groove can virtually be as small as desired, for example both less than 15 mm, preferably less than 10 mm and particularly preferably less than 5 mm.

The marker element melted in the longitudinal groove is fixed in relation to the glass cladding cylinder, which simplifies its handling during later stages of the fiber production process. Freedom from faults and the quality of the melting process are easy to check, for example before the openings in the glass cladding cylinder are filled with core rods.

In the longitudinal groove, the marker element (component, bed, layer) is melted in the longitudinal groove over at least a portion of the length thereof, preferably locally at a plurality of points distributed over its length and ideally over the entire length thereof.

In view of this, in a preferred embodiment of the semi-finished product, it is provided that the marker element has a length and that it is melted along at least 80% of this length, preferably along at least 90% of this length, completely, in parts or at points, into the longitudinal groove.

In a preferred embodiment of the semi-finished product, the marker element comprises a hollow channel filled with a gas.

The gas, such as air or nitrogen, demonstrates a particularly high increase in the refractive index with respect to the surrounding cladding glass and is therefore easy to detect even with small radial dimensions.

The longitudinal groove is preferably designed to receive a marker element which has a deviation of its axial alignment of less than 0.3 mm/m and accordingly forms highly precise marker zones in the multicore fiber obtained from the semi-finished product.

The glass cladding cylinder is preferably a hollow cylinder having a central bore.

The semi-finished product is provided for carrying out the method according to the invention and is suitable and designed for this purpose. The explanations relating to the glass cladding cylinder in connection with the method according to the invention also apply to the semi-finished product and are hereby incorporated.

### Definitions and Measurement Methods

Individual terms in the above description are further defined below. The definitions are part of the description of the invention. For terms and measuring methods that are not specifically defined in the description, the interpretation according to the International Telecommunication Union (ITU) are relevant. In the event of an inconsistency between one of the following definitions and the rest of the description, the statements made elsewhere in the description take precedence.

### Glass Cladding Cylinder/Glass Cladding Region

The glass cladding cylinder is elongated and has a substantially cylindrical shape. Deviations from the cylindrical shape can be present in the region of the end-face ends. It is designed as a solid cylinder or as a hollow cylinder. It contains a cladding glass which forms the glass cladding region. The cladding glass consists, for example, of undoped quartz glass, or it contains at least one dopant that decreases the refractive index of quartz glass. Fluorine and boron are dopants which can lower the refractive index of quartz glass.

### Core Rods/Core Glass Region

The core rods contain a core glass having a homogeneous or non-homogeneous refractive index profile in the radial direction. The core glass of each of the core rods forms a core glass region. The core rods can contain a region made of a core glass having a comparatively high refractive index and at least one further region made of another glass having a comparatively low refractive index; for example a quartz glass doped with fluorine and/or chlorine. The glass having the highest refractive index is generally located in the central axis of the core rod. It consists, for example, of quartz glass, to which at least one dopant is added to increase the refractive index. In the multicore fiber, the core rod forms at least one signal core in which the signal to be transmitted is mainly transported. The signal core can adjoin other glass regions with a smaller refractive index which have also been provided by the core rod.

### Marker Element/Marker Material/Marker Glass

The marker element contains a marker material or consists partially of air or another gas. In particular, the marker element contains at least one marker glass. The composition of the marker glass differs from that of the cladding glass and/or the density of the marker glass differs from that of the cladding glass. The marker element is present in the pre-form and in the component group as a component or as a layer or mass on a component and forms an optically detectable marker zone in the multicore fiber.

### Component Group/Consolidated Pre-Form/Secondary Pre-Form

The “component group” comprises the glass cladding cylinder with core rods inserted therein and the at least one marker element. By fixing the core rods in the core rod bores, for example by narrowing a glass cladding cylinder end or by collapsing and fusing, a “pre-form” is obtained which is also referred to here as a “consolidated pre-form”. The component group or the (consolidated) pre-form is elongated to form a “secondary pre-form”, or to directly form the multicore fiber. The term “semi-finished product” here subsumes the component group, the consolidated pre-form and the secondary pre-form. Reshaping the component group comprises the elongation to form the multicore fiber or the formation of the consolidated pre-form.

### Quartz Glass

Quartz glass is, for example, a melted product from naturally occurring SiO₂ raw material (natural quartz glass), or it is synthetically produced (synthetic quartz glass), or consists of mixtures of these quartz glass types. Synthetic, transparent quartz glass is obtained for example by flame hydrolysis or oxidation of synthetically produced silicon compounds, by polycondensation of organic silicon compounds according to what is referred to as the sol-gel method, or by hydrolysis and precipitation of inorganic silicon compounds in a liquid.

### Fusing

When components made of glass are referred to, fusing is understood to mean that the components are fused to one another on a contact surface. Fusing takes place by heating the components at least in the region of the contact surface by means of a heat source, such as a furnace, a burner, or a laser.

### Position Indications: Top/Bottom

These indications relate to positions during the elongation process and/or during the fiber drawing process. “Bottom” denotes the position in the direction of the drawing process; “top” denotes the position counter to the direction of the drawing process.

### Cross-Section

The section taken perpendicular to the longitudinal direction/longitudinal axis.

### Longitudinal Section

A section taken parallel to the longitudinal direction/longitudinal axis.

### Bore

The terms “bore”, “central bore”, “inner bore” or “longitudinal bore” denote holes having any internal geometry. They are produced, for example, by a drilling process or they are produced by depositing a material layer on the outer lateral surface of a mandrel by means of a deposition process or a pressing process and then removing the mandrel.

### EXEMPLARY EMBODIMENT

The invention is explained in more detail below with reference to an exemplary embodiment and a drawing. In detail, in a schematic representation,

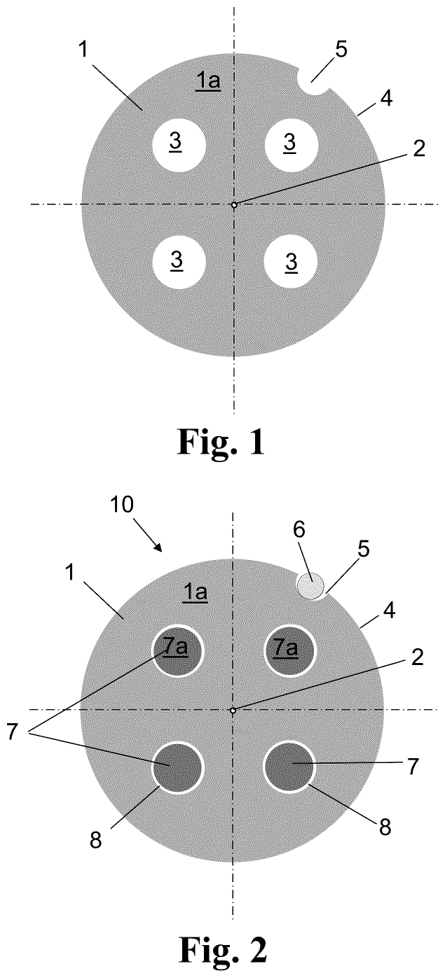

FIG. 1 is a cross section of a solid glass cladding cylinder with a longitudinal groove in the outer lateral surface and through-bores,

FIG. 2 shows a component group comprising the solid glass cladding cylinder in FIG. 1, core rods inserted into the core rod bores, and a marker element inserted into the longitudinal groove,

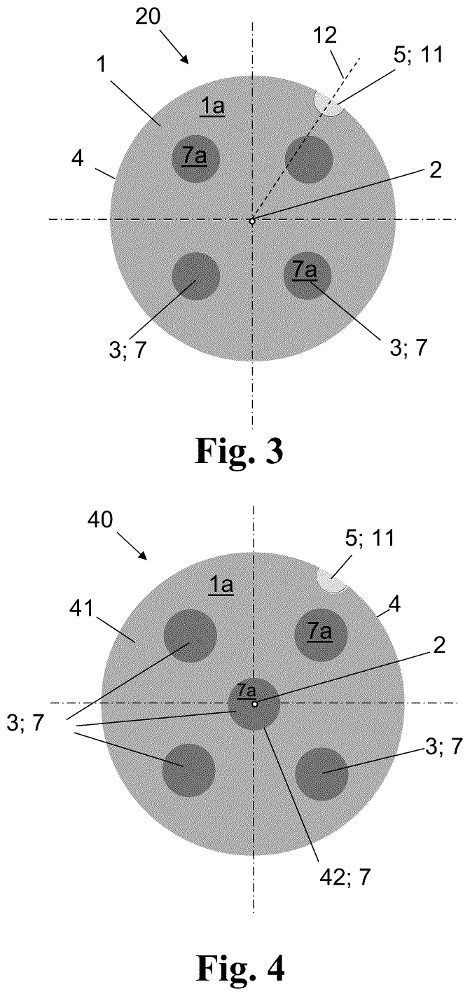

FIG. 3 is a cross section of a consolidated pre-form comprising a solid glass cladding cylinder, marker element and core rods,

FIG. 4 is a cross section of a consolidated pre-form comprising a hollow glass cladding cylinder, marker element and core rods, and

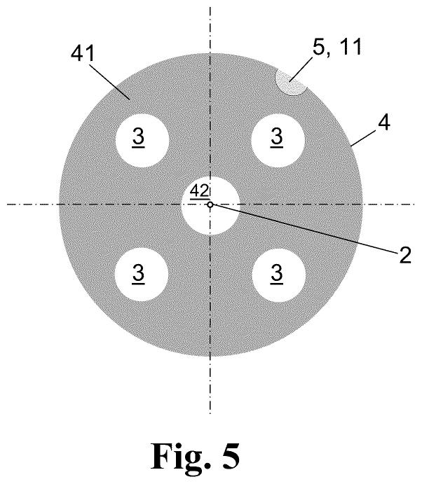

FIG. 5 is a cross section of a hollow glass cladding cylinder with a central bore and through-bores for receiving core rods.

### EXAMPLE 1

FIG. 1 schematically shows a cross section of a cylinder 1, made of a cladding glass, which serves as a base body for the production of a multicore fiber. The glass cladding cylinder 1 consists of non-doped, synthetically produced quartz glass. The quartz glass forms a glass cladding region 1a. The glass cladding cylinder 1 has a length of 1500 mm and is adjusted by cylindrical grinding to a nominal outer diameter of 200 mm. A longitudinal groove 5 is produced in the cylinder outer cladding 4. Four bores 3 are produced in a predetermined (here quadratic) configuration by mechanical drilling in the direction of the cylinder longitudinal axis 2, which runs perpendicularly to the sheet plane in the illustration of FIG. 1. The bores 3 serve to receive core rods (FIG. 2) and have a diameter of 24 mm. The bores 3 extend through the entire cylinder 1 (through-bores). In an alternative embodiment, the bores are designed as blind bores.

The longitudinal groove 5 milled into the cylinder outer cladding 4 extends over the entire length of the glass cladding cylinder 1. It is semicircular in cross section with an opening width of 10 mm and a depth of 5 mm.

FIG. 2 shows a component group 10 comprising a glass cladding cylinder 1, core rods 7 and a marker rod 6 inserted into the longitudinal groove 5. The marker rod 6 also has a length of 1500 mm and a diameter of 3.5 mm. It consists of synthetically produced quartz glass doped with fluorine and can be obtained commercially under the name F320. Both the viscosity and the refractive index of the fluorine-doped quartz glass of the marker rod 6 are smaller than in the undoped quartz glass of which the cylinder 1 consists. The marker rod 6 is obtained by elongating a starting cylinder made of F320 quartz glass in a tool-free method. It has a smooth, damage-free surface generated in the molten mass and is characterized by high dimensional stability and straightness so that it can be inserted into the longitudinal groove 5 without difficulty. The marker rod 6 inserted into the longitudinal groove 5 is melted in the longitudinal groove 5 by punctiform heating by means of a burner and is thereby fixed. The glass volume of the former marker rod 6 is matched to the spatial volume of the longitudinal groove 5 such that the marker glass 11 precisely completely fills the longitudinal groove 6. In this case, the glass cladding cylinder 1 is mounted with a horizontally oriented cylinder longitudinal axis such that the longitudinal groove 5 is located on its upper side. The glass material of the marker element 6 is heated and softened by means of a burner so that it sinks into the longitudinal groove 5 and completely fills it. Due to the surface tension, the surface of the softened glass mass adjacent to the free atmosphere shows a slight bulge.

In an alternative method variant, the marker rod 6 is melted in the longitudinal groove 5 over its entire length. A certain degree of rounding of the marker material 11 and thus an adaptation to the circular contour of the outer lateral surface of the glass cladding cylinder 1 can thereby be achieved as a result of the surface tension, as can be seen in FIG. 3. After melting the marker rod 6, freedom from defects and the melting quality are monitored and can be improved, if necessary.

In a further alternative method variant, a tube is used as a marker element which consists of quartz glass doped with a dopant which increases the viscosity of quartz glass, such as aluminum oxide (Al₂O₃). The tube has an inner diameter of 8 mm (alternatively: at least 10 mm) and also has a length of 1500 mm. During melting of the Al₂O₃-doped quartz glass tube, which is open on both sides, into the longitudinal groove 5, excess pressure is generated and maintained in the pipe bore thus preventing a collapse of the pipe bore. This pipe bore is also maintained during the later stages of the manufacturing process so that an air-filled hollow channel (“airline”) remains in the finished multicore fiber.

Moreover, in the embodiment, four core rods 7 made of Ge-doped quartz glass with a length of about 1500 mm and an outer diameter of about 22 mm are produced. Known techniques are also suitable for this purpose, for example the MCVD (modified chemical vapor deposition) method. FIG. 2 shows schematically the core rods 7 inserted into the bores 3. The core glass of the core rods 7 forms a core glass region 7a. The lower end of the glass cladding cylinder 1 fitted with the core rods 7 is then heated so that the annular gaps 8 around the core rods 7 collapse.

FIG. 3 schematically shows the thus consolidated pre-form 20 comprising the former group components: glass cladding cylinder 1, core rods 7, marker rod 6, which forms the marker glass mass 11 in the pre-form. The latter is exposed on the cylinder outer cladding 4 and on a line 12 extending radially outward from the center point, which line does not belong to the axis of symmetry of the fiber design.

The consolidated pre-form 20 is subsequently elongated to form a secondary pre-form. In this case, the pre-form 20 is held in an elongation device by means of a holder with the cylinder longitudinal axis 2 vertically aligned. The secondary pre-form produced in this way is finally drawn to form a multicore fiber in a conventional manner in a drawing device. With the exception of the smaller radial dimensions, the cross section thereof substantially corresponds to the cross section of the consolidated pre-form 20 shown in FIG. 3. The former core rods 7 form signal cores which extend along the longitudinal axis of the fiber and the former marker glass mass 11 forms a marker zone on the cylinder cladding surface of the multicore fiber. The multicore fiber is characterized by particularly low fiber curl and by particularly good splicing behavior.

### EXAMPLE 2

Insofar as the same reference numerals are used in FIGS. 4 and 5 as in FIGS. 1 to 3, identical or equivalent components or constituents of the semi-finished product are thus referred to as explained in more detail above with reference to Example 1.

FIG. 5 schematically shows a cross section of a hollow glass cladding cylinder 41 which is produced in a known manner using the OVD method. In this method, SiO₂ soot particles are formed by a high-purity SiO₂ starting material, for example silicon tetrachloride, being passed through a deposition burner and supplied to a burner flame in which solid SiO₂ is formed therefrom. This is deposited in the form of fine SiO₂ soot particles from the gas phase on the outer lateral surface of a cylindrical deposition mandrel rotating about its longitudinal axis, wherein the deposition burner executes a reversing back and forth movement along the deposition mandrel longitudinal axis. An SiO₂ soot body forms on the outer lateral surface of the deposition mandrel. After completion of the deposition process, the deposition mandrel is removed so that a central inner bore 42 remains. The SiO₂ soot body is subsequently vitrified in a furnace under vacuum, wherein the central inner bore 42 does not collapse, i.e., is maintained.

The hollow cylinder 41 thus obtained consists of non-doped, synthetically produced quartz glass. It has a length of 1500 mm and is adjusted by cylindrical grinding to an outer diameter of 200 mm and by drilling and honing to an inner diameter of 42 mm.

A longitudinal groove 5, which extends over the entire length of the glass cladding cylinder 41 and which is semi-circular in cross section and has an opening width of 10 mm and a depth of 5 mm, is milled into the cylinder outer cladding 4.

Four uniformly distributed further bores 3 having a diameter of 42 mm are produced around the central inner bore 42 by mechanical drilling in the direction of the longitudinal axis 2.

A marker rod made of synthetically produced quartz glass, which is likewise doped with fluorine and which is commercially available under the name F520, is inserted into the longitudinal groove 5. The marker rod has a length of 1500 mm, and a diameter of 7 mm. It is obtained by elongating a starting cylinder consisting of F520 quartz glass in a tool-free method and has a smooth, damage-free surface generated in the molten mass. It is characterized by high dimensional stability so that it can be inserted into the longitudinal groove 5 without difficulty. The marker rod inserted into the longitudinal groove 5 is first fixed in the longitudinal groove 5 at three fixing points by punctiform heating using a burner, wherein the fixing points are distributed over 95% of its length at the ends and in the middle. It is then melted in the longitudinal groove 5 over its entire length. In this case, the fluorine-doped quartz glass of the marker rod melts, is distributed in the longitudinal groove 5 and completely fills it. As a result of the surface tension, a certain degree of rounding of the marker glass mass 11 and thus an adaptation to the circular contour of the outer lateral surface 4 of the hollow glass cladding cylinder 41 results. The freedom from error and the quality of the melted marker glass mass 11 are monitored.

The hollow glass cladding cylinder 41 thus modified serves as a semi-finished product for the production of a multicore fiber. During the later stages of this production method, the bores 3 are each filled with the same core rods 7 having a diameter of 40 mm and the central inner bore 42 of the hollow glass cladding cylinder 41 is filled with a filler rod made of the cladding glass or of another glass material. In the embodiment, the central bore 42 is likewise filled with a core rod 7 having a diameter of 40 mm. The lower end of the glass cladding cylinder 41 equipped with the core rods 7 is then heated so that the annular gaps around the core rods 7 collapse. FIG. 4 shows schematically a pre-form 40 consolidated using the modified hollow glass cladding cylinder 41 of FIG. 5.

This consists of the former group components: the hollow glass cladding cylinder 41, which forms the glass cladding region 1a, core rods, which form the core glass regions 7a, and the marker rod, which forms the marker glass mass 11 in the pre-form 40. It is subsequently elongated to form a secondary pre-form which is finally drawn to form a multicore fiber in a conventional manner in a drawing device. The marker zone close to the edge is particularly precise and has a small volume so that the multicore fiber is characterized by particularly low fiber curl and by particularly good splicing behavior.

1. A method for producing a multicore fiber, comprising a method step in which a component group is reshaped to form the multicore fiber or to form a pre-form for the multicore fiber, the component group comprising:
a glass cladding cylinder having a cylinder longitudinal axis and an outer lateral surface and having a glass cladding region made of cladding glass;
a plurality of core glass regions provided with a core glass and extending in the direction of the cylinder longitudinal axis, which are surrounded by the cladding glass; and,
at least one marker element extending in the direction of the cylinder longitudinal axis,
wherein the marker element is arranged on the outer lateral surface of the glass cladding cylinder, a longitudinal groove being created in the outer lateral surface of the glass cladding region and extending in the direction of the cylinder longitudinal axis, and wherein the marker element is melted in the longitudinal groove before the reshaping process to form the pre-form or the multicore fiber.

2. The method according to claim 1, wherein the marker element has a length and wherein the melting takes place fully, in portions or at points along at least 80% of this length, preferably along at least 90% of this length.

3. The method according to claim 1, wherein melting of the marker element comprises a method step in which the glass cladding cylinder is mounted with a horizontally oriented cylinder longitudinal axis such that the longitudinal groove is located in an upper side of the glass cladding cylinder, the material of the marker element being heated and softened by means of a heat source.

4. The method according to claim 1, wherein cladding glass having a cladding glass volume V_{M} is removed from the glass cladding cylinder to produce the longitudinal groove, and wherein a marker element having a volume V_{E} is received in the longitudinal groove, where V_{E}=V_{M}+/−0.1×V_{M}.

5. The method according to claim 1, wherein the production of the component group comprises the following method steps:
(a) providing the glass cladding cylinder which contains the cladding glass;
(b) providing core rods containing the core glass;
(c) providing a marker element;
(d) producing at least one longitudinal groove in the outer lateral surface of the glass cladding cylinder:
(e) producing core rod bores which extend along the cylinder longitudinal axis;
(f) arranging and melting the marker element in the longitudinal groove; and
(g) introducing the core rods into the core rod bores while forming the core glass regions.

6. The method according to claim 1, wherein the marker element is provided in the form of a cylindrical component, in particular as a solid rod or as a tube, or in the form of a layer or glass mass.

7. The method according to claim 1, wherein a hollow cylinder having a central bore is used as the glass cladding cylinder and comprises the glass cladding region made of cladding glass and a plurality of core glass regions provided with a core glass.

8. The method according to claim 1, wherein the marker glass differs from the cladding glass in at least one physical and/or chemical property, the property being selected from: refractive index, color, fluorescence and/or specific glass density.

9. A semi-finished product for producing a multicore fiber, comprising a glass cladding cylinder having a cylinder longitudinal axis and an outer lateral surface and having a glass cladding region made of cladding glass which contains a plurality of openings for receiving core rods made from a core glass, wherein the outer lateral surface of the glass cladding cylinder has at least one recess extending in the direction of the cylinder longitudinal axis and designed as a longitudinal groove, into which a marker element is melted.

10. The semi-finished product according to claim 9, wherein the marker element has a length and wherein said marker element is melted fully, in portions or at points, along at least 80% of this length, preferably along at least 90% of this length.

11. The semi-finished product according to claim 9, wherein the marker element comprises a channel filled with a gas.

12. The semi-finished product according to claim 9, wherein the glass cladding cylinder is a hollow cylinder having a central bore.
